(19) United States
(12) Patent Application Publication
(10) Pub. No.: US 2026/0265022 A1
(43) Pub. Date: Sep. 10, 2026

(54) MACHINE ROOM-LESS ELEVATOR TRACTION SYSTEM AND ELEVATOR EQUIPMENT

(71) Applicant: Otis Elevator Company, Farmington, CT (US)

(72) Inventors: Hong Fu, Tianjin (CN); Zhe Zhang, Tianjin (CN)

(21) Appl. No.: 19/406,172

(22) Filed: Dec. 2, 2025

(30) Foreign Application Priority Data
Mar. 10, 2025 (CN) 202510279245.0

(51) Int. Cl. B66B 11/00; B66B 1/30; B66B 17/12

(52) U.S. Cl. CPC B66B 11/0065; B66B 1/30; B66B 11/0045; B66B 17/12

(57) ABSTRACT

A machine room-less elevator traction system includes a power device including at least a first traction part and a second traction part, a guiding device arranged on an elevator car, and a tension device comprising at least a first tension member and a second tension member, the first tension member is in drive connection with the first traction part, with a first end of the first tension member connected to an elevator counterweight, and a second end of the first tension member fixed to the upper portion of the elevator hoistway after passing through the guiding device; the second tension member is in drive connection with the second traction part, with a first end of the second tension member connected to the elevator counterweight, and a second end of the second tension member fixed to the upper portion of the elevator hoistway after passing through the guiding device.

### FOREIGN PRIORITY

This application claims priority to Chinese Patent Application No. 202510279245.0, filed Mar. 10, 2025, and all the benefits accruing therefrom under 35 U.S.C. § 119, the contents of which in its entirety are herein incorporated by reference.

### TECHNICAL FIELD OF INVENTION

The present disclosure relates to the technical field of elevators, and in particular, to a machine room-less elevator traction system and elevator equipment.

### BACKGROUND OF THE INVENTION

Elevator equipment is typically equipped with an elevator car and a counterweight. The elevator car moves up and down along the guide rails within the elevator hoistway to transport passengers, goods, and the like. The counterweight serves to balance the weight of the car and its load, operating in reverse linkage with the elevator car. That is, when the elevator car moves up, the counterweight synchronously moves down along the guide rails, and vice versa, in order to achieve dynamic load balancing.

Elevator equipment often adopts a traction drive approach, which connects the elevator car and counterweight using ropes such as steel cables, that is, connecting the two ends of the ropes to the elevator car and counterweight, respectively. Driven by the power provided by the elevator equipment (e.g., typically a traction machine driving a traction sheave to rotate), power can be transmitted to the ropes wrapped around the traction sheave, and then the elevator car and counterweight can be driven by the ropes for synchronized movement.

### SUMMARY OF THE INVENTION

In view of the foregoing, the present disclosure provides a machine room-less elevator traction system and elevator equipment, so as to solve or at least alleviate the problems existing in the prior art and one or more problems in other aspects, or to provide alternative solutions for the prior art.

Firstly, according to one aspect of the present disclosure, a machine room-less elevator traction system is provided, which comprises: a power device, comprising at least a first traction part and a second traction part, the first traction part and the second traction part being arranged at an upper portion of an elevator hoistway; a guiding device, arranged on an elevator car; and a tension device, comprising at least a first tension member and a second tension member, wherein the first tension member is in drive connection with the first traction part, with a first end of the first tension member connected to an elevator counterweight, and a second end of the first tension member fixed to the upper portion of the elevator hoistway after passing through the guiding device; the second tension member is in drive connection with the second traction part, with a first end of the second tension member connected to the elevator counterweight, and a second end of the second tension member fixed to the upper portion of the elevator hoistway after passing through the guiding device; wherein the power device is connected to an elevator controller which controls operation of the power device such that the first tension member and the second tension member are driven by the first traction part and the second traction part respectively to drive the elevator car and the elevator counterweight to move within the elevator hoistway.

In a machine room-less elevator traction system according to the present disclosure, optionally, the power device is arranged on an inner wall on one side of the elevator hoistway, and the second end of the first tension member and the second end of the second tension member are both fixed on an inner wall on another side of the elevator hoistway.

In a machine room-less elevator traction system according to the present disclosure, optionally, the second end of the first tension member and the second end of the second tension member are both fixed above a top floor landing door of the elevator.

In a machine room-less elevator traction system according to the present disclosure, optionally, the first traction part is a first traction machine and is arranged on a first bracket, the second traction part is a second traction machine and is arranged on a second bracket, and the first bracket and the second bracket are both mounted on an inner wall on the same side of the elevator hoistway; or the power device is a traction machine and is configured to distribute an output power to the first traction part and the second traction part through a power distribution mechanism.

In a machine room-less elevator traction system according to the present disclosure, optionally, the first bracket and the second bracket are integrally formed, or the first bracket and the second bracket are arranged at intervals and located in the same horizontal plane which is perpendicular to a vertical direction of the elevator hoistway.

In a machine room-less elevator traction system according to the present disclosure, optionally, the first bracket and the second bracket are configured such that: in a horizontal plane perpendicular to the vertical direction of the elevator hoistway, respective projections of the first bracket and the second bracket in the horizontal plane are both outside a projection of an outer contour of the elevator car in the horizontal plane.

In a machine room-less elevator traction system according to the present disclosure, optionally, the guiding device comprises at least a first guide member and a second guide member, the second end of the first tension member is fixed to the upper portion of the elevator hoistway by passing through the first guide member, and the second end of the second tension member is fixed to the upper portion of the elevator hoistway by passing through the second guiding member.

In a machine room-less elevator traction system according to the present disclosure, optionally, the first guide member and the second guide member are both arranged at the top of the elevator car, and the first guide member is arranged adjacent to one side of the elevator car, and the second guide member is arranged adjacent to another side of the elevator car.

In a machine room-less elevator traction system according to the present disclosure, optionally, the first guide member comprises one or more guide wheels, and the second guide member comprises one or more guide wheels; and/or, the first guide member and the second guide member are symmetrically arranged on the elevator car.

In a machine room-less elevator traction system according to the present disclosure, optionally, the machine room-less elevator traction system further comprises a first fixing device and a second fixing device, the power device is arranged on an inner wall on one side of the elevator hoistway, the first fixing device and the second fixing device are both fixed on an inner wall on another side of the elevator hoistway, the second end of the first tension member is fixedly connected to the first fixing device, and the second end of the second tension member is fixedly connected to the second fixing device.

In a machine room-less elevator traction system according to the present disclosure, optionally, the first fixing device and the second fixing device are configured such that: in a horizontal plane perpendicular to the vertical direction of the elevator hoistway, respective projections of the first fixing device and the second fixing device in the horizontal plane are both outside a projection of an outer contour of the elevator car in the horizontal plane; and/or in the vertical direction of the elevator hoistway, respective positions of the first fixing device and the second fixing device are both not lower than a position of the power device.

In a machine room-less elevator traction system according to the present disclosure, optionally, the first traction part includes a motor, the second traction part includes a motor, the first tension member includes a steel belt and a steel cable, and the second tension member comprises a steel belt and a steel cable; and/or, the first traction part and the second traction part are configured to have the same configuration, and the first tension member and the second tension member are configured to have the same configuration.

In addition, according to another aspect of the present disclosure, elevator equipment is further provided, comprising: the machine room-less elevator traction system according to any of the above; an elevator car and an elevator counterweight, wherein the guiding device of the machine room-less elevator traction system is arranged on the elevator car, the respective first ends of the first tension member and the second tension member are connected to the elevator counterweight, and the respective second ends of the first tension member and the second tension member are fixed to an upper portion of the elevator hoistway after passing through the guiding device; and an elevator controller, connected to the power device and configured to control operation of the power device such that the first tension member and the second tension member are driven by the first traction part and the second traction part respectively to drive the elevator car and the elevator counterweight to move within the elevator hoistway.

In the elevator equipment according to the present disclosure, optionally, the elevator controller is configured to control the first traction part and the second traction part to operate synchronously, and to control the power device to stop operating when corresponding operational parameters between the first traction part and the second traction part exceed a preset synchronization tolerance threshold.

In the elevator equipment according to the present disclosure, optionally, the operational parameter includes at least one of voltage, current, rotational speed, and output torque.

The solutions according to the present disclosure can support the realization of a reduced elevator top floor headroom, improve the space utilization of the elevator hoistway, and optimize the return-rope configuration at the top of the elevator hoistway. In addition, it can enhance the structural strength of the elevator car frame and lower the manufacturing cost for the counterweight, thus helping to reduce the overall cost of the system. The machine room-less elevator traction systems according to the present disclosure are easy to manufacture, install and use, and have robust safety performance, and thus can be widely used in many places such as public elevators, home lifts, and the like.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of existing elevator equipment.

FIG. 2 is a partial side-view structural schematic diagram of an embodiment of a machine room-less elevator traction system according to the present disclosure mounted on an example of elevator equipment.

FIG. 3 is a partial top-view structural schematic diagram of the machine room-less elevator traction system shown in FIG. 2 mounted on an example of elevator equipment.

### DETAILED DESCRIPTION OF THE INVENTION

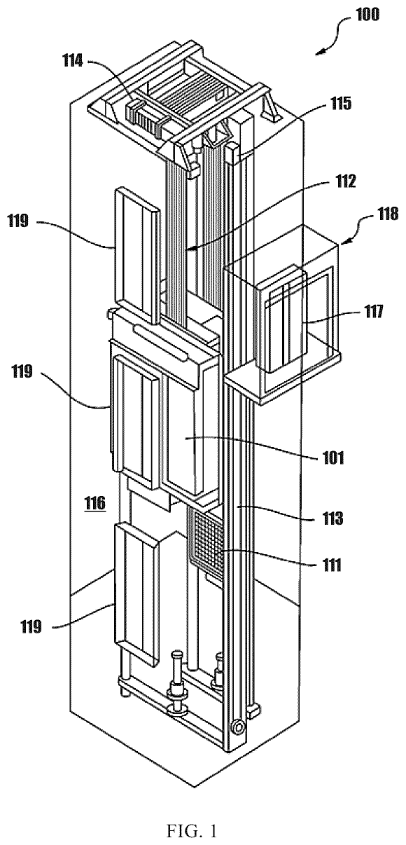

FIG. 1 is a perspective view of existing elevator equipment 100 including an elevator car 101, a counterweight 111, a tension member 112, a guide rail (or rail system) 113, a machine (or machine system) 114, a position reference device 115, and an electronic elevator controller (controller) 117. The elevator car 101 and elevator counterweight 111 are connected to each other by the tension member 112, and travel along the elevator hoistway 116 under the action of driving force. The tension member 112 may include, for example, steel belts (such as coated-steel belts) and/or ropes (such as steel cables). The elevator counterweight 111 is configured to balance a load of the elevator car 101 and is configured to facilitate movement of the elevator car 101 concurrently and in an opposite direction with respect to the counterweight 111 within an elevator hoistway 116 and along the guide rail 113.

The tension member 112 engages the machine 114. The machine 114 is configured to control movement between the elevator car 101 and the counterweight 111. Machine 114 may include a motor or similar traction machine to provide driving force to elevator equipment 100, where the machine 114 can be mounted on a crossbeam located at the top of the elevator car 101. The position reference device 115 may be arranged in other positions and/or configurations known in the art, such as being mounted on a fixed part at the top of the elevator hoistway 116. The position reference device 115 may be configured to provide position signals related to a position of the elevator car and/or elevator counterweight within the elevator hoistway. The position reference device 115 can employ any device or mechanism for monitoring a position of an elevator car and/or elevator counterweight, as known in the art. For example, it includes but is not limited to an encoder, a sensor, or other component, and may include speed sensing, absolute position sensing, and the like.

The controller 117 may be located in a controller room 118 of the elevator hoistway 116 and may be configured to control the operation of the elevator equipment 100, and particularly the elevator car 101. For example, the controller 117 may provide drive signals to the machine 114 to control the acceleration, deceleration, leveling, stopping, etc. of the elevator car 101. The controller 117 may also be configured to receive position signals from the position reference device 115 or any other desired device or system of this kind. When moving up or down within the elevator hoistway 116 along guide rail 113, the elevator car 101 may stop at one or more landings 119 as controlled by the controller 117. Although shown in a controller room 118, those of skill in the art will appreciate that the controller 117 can be located and/or configured in other locations or positions within the elevator equipment 100, such as located remotely or in the cloud.

Specific elevator equipment and components are illustrated and described above. Unless otherwise specified herein, the components in the example of the elevator equipment of FIG. 1 can be applied to the elevator equipment according to the present disclosure to achieve the same or similar functionalities. Compared with existing technical solutions, the present disclosure provides an innovative machine room-less elevator traction system for elevator equipment, which has significant advantages in achieving reduced overhead hoistway height, improved hoistway space utilization, enhanced structural performance of the car, and reduced system costs. It is particularly suitable for environments with relatively limited elevator hoistway space dimensions, such as application scenarios of home lifts, and the like.

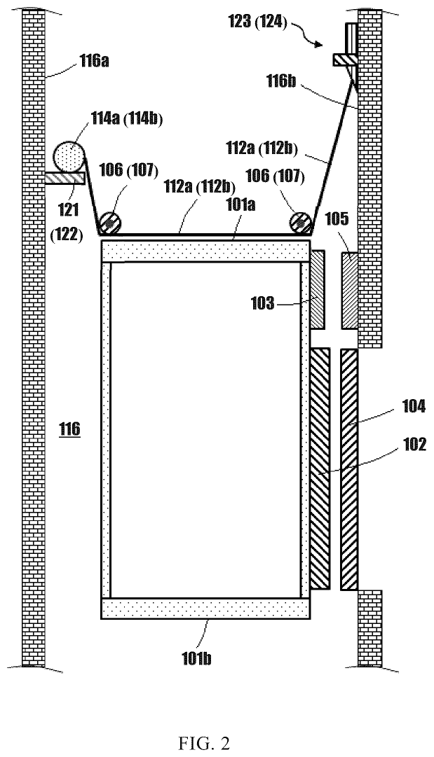

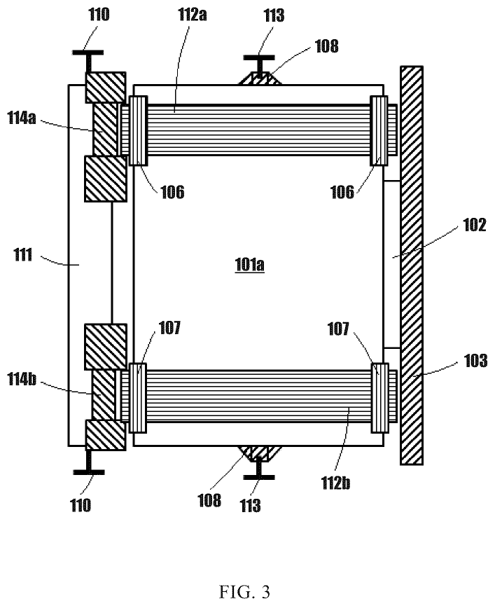

The solutions according to the present disclosure will be described in detail below in conjunction with the specific embodiment of FIGS. 2 and 3. For the sake of simplification of the drawing, identical or similar components and features may only be denoted in one or several places in the same drawing. Technical terms such as “first” and “second” are only used for distinguishing purposes and are not intended to indicate the order and relative importance thereof. The technical term “connect” includes the realization of connection in a direct or an indirect manner.

Referring to FIGS. 2 and 3, the configuration of an embodiment of a machine room-less elevator traction system according to the present disclosure is only schematically illustrated in these figures. As shown in FIGS. 2 and 3, the embodiment of the machine room-less elevator traction system may include a first traction part 114a, a second traction part 114b, a first tension member 112a, a second tension member 112b, a first guiding member 106, and a second guiding member 107.

Specifically, the power device in the embodiment of the machine room-less elevator traction system may be constituted by the first traction part 114a and the second traction part 114b. The power device is connected to the controller 117 so that the operation of the power device can be controlled through the controller 117. The driving force is provided to the elevator equipment through the first traction part 114a and the second traction part 114b, so that the elevator car 101 can move along the guide rail 113, and at the same time, the elevator counterweight 111 can move in the opposite direction along the guide rail 110, thus forming a reverse linkage. The above configuration is schematically illustrated in FIGS. 2 and 3. For ease of understanding, some components of the example of the elevator equipment are also shown in the above figures, such as the car door 102, the car door header 103, the landing door 104, the landing door header 105, and the guide shoe 108. The guide shoe 108 may be mounted on the bottom frame 101b of the elevator car 101, and the elevator car 101 may be fixed to the guide rail 113 with the help of the guide shoe 108.

The first traction part 114a and the second traction part 114b may have the same or different configurations, for example, they may employ the same type of motor or similar traction machines. As an alternative solution, the first traction part 114a and the second traction part 114b can also be achieved by distributing the output power of a power device, such as a traction machine, through a power distribution mechanism. The above power distribution mechanism may be configured with any feasible mechanical structure, device, or equipment, etc., such as using gears, chains, belts, etc. to distribute the output power of the power device accordingly by means of mechanical linkage, such as evenly distributing it to the first traction part 114a and the second traction part 114b.

During practical use, the controller 117 may be used to control the synchronous operation of the first traction part 114a and the second traction part 114b. As an optional scenario, the controller 117 may be configured to control the power device to stop operating once the corresponding operational parameters between the first traction part 114a and the second traction part 114b exceed a preset synchronization tolerance threshold (which may be specifically set and adjusted according to actual application needs), thereby enhancing system safety. The above operational parameters may include but are not limited to one or more of voltage, current, rotational speed, and output torque. When at least two types of operational parameters are selected for analysis and processing simultaneously, it can effectively improve the accuracy of judgment and avoid misjudgment and misoperation.

The first bracket 121 and the second bracket 122 may be mounted on an inner wall 116a on one side of the elevator hoistway 116. For example, they can be spaced apart and arranged in the same horizontal plane perpendicular to the vertical direction Z of the elevator hoistway 116. The first traction part 114a and the second traction part 114b can then be mounted to the first bracket 121 and the second bracket 122, respectively, thus forming a machine room-less configuration. This avoids the conventional installation approach of adding crossbeams at the top of the hoistway, which is commonly used in existing technical solutions. Such arrangement facilitates supporting a smaller minimum overhead height, and achieving higher hoistway space utilization.

The first bracket 121 and the second bracket 122 may adopt the same configuration or different configurations as needed. For example, they can be separately configured brackets, respectively, or they can serve as integral frames of the first traction part 114a and the second traction part 114b, respectively. In one or some embodiments, the first bracket 121 and the second bracket 122 can be integrally formed to facilitate overall installation and use. In one or some embodiments, the first bracket 121 and the second bracket 122 can be configured such that their respective projections in a horizontal plane perpendicular to the vertical direction Z are outside the projection of the outer contour of the elevator car 101 (e.g., the outer contour in the case where a top guardrail and other components are installed) in the above horizontal plane. This ensures that even when the elevator car 101 moves up to the installation position of the power device, no interference occurs between the elevator car 101 and the above brackets, which is conducive to ensuring system safety.

The first traction part 114a and the second traction part 114b may be respectively engaged to the first tension member 112a and the second tension member 112b to form a drive connection with them, so that the elevator car 101 and the elevator counterweight 111 can be driven in reverse linkage through the first tension member 112a and the second tension member 112b when needed. The above first tension member 112a and the second tension member 112b constitute the tension device in this embodiment of the machine room-less elevator traction system. The tension device differs from the tension members in the elevator equipment 100 shown in FIG. 1 in terms of specific configuration and arrangement, etc., which will be described in detail below.

For the first tension member 112a and the second tension member 112b, they may use steel belts and/or steel cables, etc. as mentioned above as needed. One end of the first tension member 112a may be connected to the elevator counterweight 111, and the other end thereof may be fixed to the upper portion of the elevator hoistway 116, for example, as schematically shown in FIG. 2, fixed to the inner wall 116b on the opposite side of the inner wall 116a where the power device is mounted, such as fixed to the inner wall 116b above the landing door 104 located on the top floor of the elevator. In specific applications, the present disclosure allows for the selection of any suitable method to fix the end of the first tension member 112a in place on the inner wall 116b of the elevator hoistway 116, and does not impose any restrictions on this. For example, holes can be drilled on the inner wall 116b and connecting pieces such as bolts can be used to connect the end of the first tension member 112a. For another example, a fixing device 123 can be mounted on the inner wall 116b to connect the end of the first tension member 112a. This type of fixing device 123 can be designed and used as needed. For example, it can be constructed into a structure that can be operably engaged (such as matching wedges and slots), and the end of the first tension member 112a can be fixed to this type of structure.

The first tension member 112a is in drive connection with the first traction part 114a to receive and transmit driving force. For example, a traction sheave (not shown) can be mounted at the power output end of the first traction part 114a, and the first tension member 112a can be wound around the traction sheave to receive and transmit the driving force from the first traction part 114a. With reference to FIGS. 2 and 3 in conjunction, one or several first guide members 106 can be mounted at suitable positions such as the top portion 101a of the elevator car 101. These guide members can guide the travel trajectory of the first tension member 112a during elevator operation, and provide support and transmit driving force to the elevator car 101 through the frictional contact with the first tension member 112a. As an optional configuration, the first guide member 106 can use components such as guide wheels, and the specific configuration model, arrangement quantity, and position, etc. thereof can be designed as needed.

For the second tension member 112b, it may adopt the same or similar configuration and arrangement as the first tension member 112a. For example, a second fixing device 124 can be optionally configured for the second tension member 112b to fix the end of the second tension member 112b in place on the inner wall 116b of the elevator hoistway 116. Therefore, reference can be made to the corresponding description of the first tension member 112a in the previous text, which will not be repeated here.

It should be appreciated that by simultaneously providing support to the elevator car 101 through the first tension member 112a and the second tension member 112b, the overall force balance can be promoted, which is beneficial for maintaining the stability of the elevator car and allowing for relatively higher frame structure strength. In addition, compared with existing technical solutions, such arrangement can significantly reduce the number of return-rope structures arranged at the top of the hoistway, thus optimizing the overall structural design of the traction system. Moreover, due to the fact that the elevator counterweight 111 can simultaneously connect the first tension member 112a and the second tension member 112b, the elevator counterweight can have a relatively larger width, allowing for the use of elevator counterweight fillers with lower cost, which can effectively reduce costs.

It should be noted that in one or some embodiments, the first fixing device 123 and the second fixing device 124 mentioned above can be arranged such that their respective projections in the horizontal plane perpendicular to the vertical direction Z of the elevator hoistway 116 are outside the projection of the outer contour of the elevator car 101 (e.g., the outer contour in the case where a top guardrail, etc. is mounted) in the above horizontal plane. This can avoid unexpected interference problems when the elevator car 101 moves up to the installation positions of these fixing devices, which is conducive to better ensuring system safety. In addition, in one or some embodiments, the first fixing device 123 and the second fixing device 124 can be configured such that their respective positions in the vertical direction Z are not lower than the position of the power device in the vertical direction Z. This is conducive to extending the adjustment range of the first tension member 112a and the second tension member 112b, so as to help to effectively maintain the stability of the elevator car and allowing it to move up and down, thus improving the hoistway space utilization.

The second guide member 107 is used in conjunction with the second tension member 112b, and can employ the same or similar configuration as the first guide member 106 as needed. Therefore, reference can be made to the corresponding description of the first guide member 106 in the previous text, which will not be repeated here. In the given embodiment of the machine room-less elevator traction system, the first guide member 106 and the second guide member 107 constitute a guide device used in conjunction with the tension device.

As used herein, in one or more embodiments, both the first tension member 112a and the second tension member 112b may be arranged symmetrically on the elevator car 101. In addition, the first guide member 106 and the second guide member 107 may be respectively arranged close to the opposing two sides of the elevator car 101, i.e., may be distributed on both sides of the car door 102. This configuration can create a relatively large space in the middle of the top portion 101a of the elevator car 101, so as not to affect the installation of devices such as guardrails and operation boxes. Elevator maintenance personnel and other staff can also have sufficient working space when carrying out equipment maintenance and upkeep operations, and they will not have problems of, for example, confined car roof working space or even difficulty in entering the car roof, as affected by the installation positions of the rope fastening structures, traction machines, etc. commonly found in conventional elevator equipment.

according to the present disclosure have been schematically described in conjunction with the example in FIGS. 2 and 3. It should be appreciated that the solutions according to the present disclosure allow for more possible embodiments. For example, as discussed above, two traction parts can be configured simultaneously for the power device. However, in some application scenarios, three or more traction parts can be configured for the power device as needed, and components such as tension members and guide members can be added accordingly. These traction parts may work synchronously, which is beneficial for improving the safety redundancy of the system. For another example, one or more guide members of the aforementioned guiding device can be adjusted to be mounted on other positions such as the side of the elevator car. For yet another example, in the case where a crossbeam is already mounted at the upper portion of the elevator hoistway, one end of the one or more tension members in the tension device as mentioned above can be fixed to the crossbeam.

The machine room-less elevator traction system and elevator equipment according to the present disclosure have been described in detail above by way of examples. It should be noted that these examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be limited by the claims of the present disclosure.

What is claimed is:

1. A machine room-less elevator traction system, comprising:
a power device, comprising at least a first traction part and a second traction part, the first traction part and the second traction part being arranged at an upper portion of an elevator hoistway;
a guiding device, arranged on an elevator car; and
a tension device, comprising at least a first tension member and a second tension member, wherein the first tension member is in drive connection with the first traction part, with a first end of the first tension member connected to an elevator counterweight, and a second end of the first tension member fixed to the upper portion of the elevator hoistway after passing through the guiding device; the second tension member is in drive connection with the second traction part, with a first end of the second tension member connected to the elevator counterweight, and a second end of the second tension member fixed to the upper portion of the elevator hoistway after passing through the guiding device;
wherein the power device is connected to an elevator controller which controls operation of the power device such that the first tension member and the second tension member are driven by the first traction part and the second traction part respectively to drive the elevator car and the elevator counterweight to move within the elevator hoistway.

2. The machine room-less elevator traction system according to claim 1, wherein the power device is arranged on an inner wall on one side of the elevator hoistway, and the second end of the first tension member and the second end of the second tension member are both fixed on an inner wall on another side of the elevator hoistway.

3. The machine room-less elevator traction system according to claim 2, wherein the second end of the first tension member and the second end of the second tension member are both fixed above a top floor landing door of an elevator.

4. The machine room-less elevator traction system according to claim 1, wherein the first traction part is a first traction machine and is arranged on a first bracket, the second traction part is a second traction machine and is arranged on a second bracket, and the first bracket and the second bracket are both mounted on an inner wall on the same side of the elevator hoistway; or
the power device is a traction machine and is configured to distribute an output power to the first traction part and the second traction part through a power distribution mechanism.

5. The machine room-less elevator traction system according to claim 4, wherein the first bracket and the second bracket are integrally formed, or the first bracket and the second bracket are arranged at intervals and located in the same horizontal plane which is perpendicular to a vertical direction of the elevator hoistway.

6. The machine room-less elevator traction system according to claim 4, wherein the first bracket and the second bracket are configured such that: in a horizontal plane perpendicular to the vertical direction of the elevator hoistway, respective projections of the first bracket and the second bracket in the horizontal plane are both outside a projection of an outer contour of the elevator car in the horizontal plane.

7. The machine room-less elevator traction system according to claim 1, wherein the guiding device comprises at least a first guide member and a second guide member, the second end of the first tension member is fixed to the upper portion of the elevator hoistway by passing through the first guide member, and the second end of the second tension member is fixed to the upper portion of the elevator hoistway by passing through the second guiding member.

8. The machine room-less elevator traction system according to claim 7, wherein the first guide member and the second guide member are both arranged at the top of the elevator car, and the first guide member is arranged adjacent to one side of the elevator car, and the second guide member is arranged adjacent to another side of the elevator car.

9. The machine room-less elevator traction system according to claim 7, wherein the first guide member comprises one or more guide wheels, and the second guide member comprises one or more guide wheels; and/or, the first guide member and the second guide member are symmetrically arranged on the elevator car.

10. The machine room-less elevator traction system according to claim 1, wherein the machine room-less elevator traction system further comprises a first fixing device and a second fixing device, the power device is arranged on an inner wall on one side of the elevator hoistway, the first fixing device and the second fixing device are both fixed on an inner wall on another side of the elevator hoistway, the second end of the first tension member is fixedly connected to the first fixing device, and the second end of the second tension member is fixedly connected to the second fixing device.

11. The machine room-less elevator traction system according to claim 10, wherein the first fixing device and the second fixing device are configured such that:
in a horizontal plane perpendicular to the vertical direction of the elevator hoistway, respective projections of the first fixing device and the second fixing device in the horizontal plane are both outside a projection of an outer contour of the elevator car in the horizontal plane; and/or
in the vertical direction of the elevator hoistway, respective positions of the first fixing device and the second fixing device are both not lower than a position of the power device.

12. The machine room-less elevator traction system according to claim 1, wherein the first traction part includes a motor, the second traction part includes a motor, the first tension member includes a steel belt and a steel cable, and the second tension member comprises a steel belt and a steel cable; and/or, the first traction part and the second traction part are configured to have the same configuration, and the first tension member and the second tension member are configured to have the same configuration.

13. Elevator equipment, comprising:
the machine room-less elevator traction system according to claim 1;
an elevator car and an elevator counterweight, wherein the guiding device of the machine room-less elevator traction system is arranged on the elevator car, the respective first ends of the first tension member and the second tension member are connected to the elevator counterweight, and the respective second ends of the first tension member and the second tension member are fixed to an upper portion of the elevator hoistway after passing through the guiding device; and
an elevator controller, connected to the power device and configured to control operation of the power device such that the first tension member and the second tension member are driven by the first traction part and the second traction part respectively to drive the elevator car and the elevator counterweight to move within the elevator hoistway.

14. The elevator equipment according to claim 13, wherein the elevator controller is configured to control the first traction part and the second traction part to operate synchronously, and to control the power device to stop operating when corresponding operational parameters between the first traction part and the second traction part exceed a preset synchronization tolerance threshold.

15. The elevator equipment according to claim 14, wherein the operational parameter includes at least one of voltage, current, rotational speed, and output torque.
